(19) United States
(12) Patent Application Publication
(10) Pub. No.: US 2009/0289234 A1
(43) Pub. Date: Nov. 26, 2009

(54) Modified Organoclays

(76) Inventors: Werner J. Blau, County Dublin (IE); Ramesh Babu Padamati, Dublin (IE)

Correspondence Address: JACOBSON HOLMAN PLLC, 400 SEVENTH STREET N.W., SUITE 600, WASHINGTON, DC, 20004, US

(21) Appl. No.: 12/226,318

(22) PCT Filed: Apr. 18, 2007
(86) PCT No.: PCT/IE2007/000049

§ 371 Date: Oct. 15, 2008

(30) Foreign Application Priority Data
Apr. 19, 2006 (IE) 2006/0309

(51) Int. Cl. H01B 1/12; C09K 3/00

(52) U.S. Cl. 252/519.21; 252/182.3; 252/519.2; 977/742; 977/762; 977/750; 977/752; 977/811

(57) ABSTRACT

A process for the preparation of modified nanoclay in one case comprises the steps of providing an organoclay, dispersing the organoclay in a solvent or mixture of solvents and/or surfactant, providing nariotubes or nanowires, dispersing the nanotubes or nanowires in a solvent or mixture of solvents and/or surfactant, and mixing the organoclay suspension with the nanotube and/or nanowire suspension. The organoclays modified with nanowires or nanotubes provide nanoadditives, which have enhanced thermal stability and electrical conductivity properties. The nanoadditive may include an inherently conducting polymer such as polyaniline. Also provided are polymer composites including the nanoadditive.

The present invention relates to a process for the preparation of modified organoclays and the use of such clays in the preparation of polymer composites.

Polymers and plastics containing clay additives have recently become widely used as replacements for heavier steel and other metal products, especially in the field of automotive manufacturing. They have found use in a growing number of areas, such as construction materials and as replacements for heavier metal parts in automobile industry. Using extrusion and injection moulding, polymers have been successfully reinforced with organoclays. Such products, often called nanocomposites, have enhanced structural, thermal, tensile, impact and flexural strength.

Nanocomposites are most often prepared today using organically modified, silicates or organoclays produced by a cation exchange reaction between the silicate and an alkyl ammonium salt (usually quaternary ammonium compounds such as dimethyl dihydrogenated tallow ammonium chloride, dimethyl benzyl hydrogenated tallow ammonium chloride, and methyl benzyl dihydrogenated tallow ammonium chloride). When preparing nanocomposites, elevated temperatures are necessary for nanocomposite processing. If the process temperature is greater then the thermal stability of the organoclay, decomposition occurs thereby altering the compatibility between the polymer matrix and organoclay. The onset of the thermal decomposition of the organic modifier (alkyl ammonium salt) in the organoclay sets the ceiling temperature for polymer processing.

Organically modified clays, also called organoclays, have been used for many years as rheological additives for solvent based systems. They are usually produced by making a water dispersion of phyllosilicate clay, usually smectite clay, and adding to it a quaternary ammonium salt of a long chain fatty acid to produce organically modified clay by cation exchange reaction and adsorption. The reaction may cause the organoclay to coagulate from the water dispersion which allows for its isolation by filtration and washing.

Wilkie et al disclose the preparation of an organoclay with enhanced thermal stability. (“A stibonium-modified clay and its Polystyrene nanocomposite”, Polymer Degradation and stability 82 (2003) 309-315). Organoclay modified with triphenylhexadecylstibonium trifluoromethylsulfonate showed significantly higher thermal stabilities over commercial Nanoclays. However multiple synthesis steps are involved and the modified organoclay did not show compatibility with all the polymer matrices used.

Awad et al (Thermochimica Acta, 409 (2004)3-11) disclose modification of layered silicates with imidazolonium salts and their applications in nanocomposites. Montmorillonite clay treated with imidazolium salts showed superior thermal properties in nitrogen atmosphere however, the thermal properties are inferior in air atmosphere. The resulting organoclays only limited compatibility with polymers.

WO03/078315 (Nagy et al) describes a nanocomposite comprising a matrix of at least one polymer filled with carbon nanotubes and organo-modified layered silicate nanoparticles. Nanotubes and nanoclay are added separately to the polymer. The clays used are not conductive.

Most of the above examples describe the preparation of organoclays that are easy to process yet difficult to disperse in various polymer matrices because of their processing limitations such as compatibility and thermal stabilities.

There is a need for modified organoclays which may be prepared easily and easily dispersed in polymer matrices.

### STATEMENTS OF INVENTION

According to the invention, there is provided a process for the preparation of modified nanoclay comprising the steps of
providing an organoclay;
dispersing the organoclay in a solvent or mixture of solvents and/or surfactant;
providing nanotubes, nanowires or nanorods;
dispersing the nanotubes, nanowires or nanorods in a solvent or mixture of solvents and/or surfactant; and
mixing the organoclay suspension with the nanotube and/or nanowire or nanorod suspension.

In one embodiment the organoclay is dispersed in a surfactant and suspended in a solvent prior to mixing with the nanotubes, nanowires or nanorods.

In one case, the nanotubes, nanowires or nanorods are dispersed in a solvent.

The organoclay may be suspended in a solvent and the nanotubes, nanowires or nanorods may be dispersed in a surfactant prior to mixing. In one case, after mixing of the organoclay suspension with the nanotube, nanowire or nanorod dispersion a surfactant is added.

In one embodiment the solvent is selected from any one or more of water, acetone, ethanol, methanol, butanol, chloroform, dimethyl formamide, tetrahydrofuran, dimethylacetamide, N-methylformamide, xylene, toluene, dimethyl sulfoxide, propylene and carbonate.

In one embodiment the surfactant is selected from any one or more of quaternary ammonium salts, non-ionic surfactants, and fatty acid hydroxyethyl imidazolines. The quaternary ammonium salts may be selected from any one or more of dimethyl dihydrogenated tallow ammonium chloride, dimethyl benzyl hydrogenated tallow ammonium chloride, methyl benzyl dihydrogenated tallow ammonium chloride, and fatty acid hydroxyethyl imidazolines.

In one embodiment the nanotube, nanowire or nanorod is selected from any one or more of carbon nanotubes (CNT), single walled carbon nanotubes (SWCNT-CNI), MO6 nanowires, and Arc discharge multi-walled carbon nanotube (MWCNT) soot.

The nanotubes may be of carbon including nanotubes selected from a single wall nanotube (SWNT), a double wall nanotube (DWNT), a multiwall nanotube (MWNT) or a nanotube produced by arc discharge, laser processing or catalytic decomposition of carbon-containing molecules.

The organoclay and nanotubes, nanowires or nanorods may be mixed at room temperature. Any solvent may be evaporated or removed from the modified nanoclay.

The invention also provides a process for the preparation of modified nanoclays comprising the steps of
providing an organoclay;
dispersing the organoclay in a surfactant;
suspending the dispersed clay in a solvent;
providing carbon nanotubes, nanowires or nanorods;
dispersing the carbon nanotubes, nanowires and/or nanorods in a solvent; and
mixing the suspended nanoclay with the carbon nanotube, nanowire or nanorod dispersion.

The invention further provides a process for the preparation of modified nanoclays comprising the steps of
providing an organoclay;
dispersing the organoclay in a solvent;
providing carbon nanotubes, nanowires or nanorods;
dispersing the carbon nanotubes nanowires, or nanorods in a solvent; and
mixing the nanoclay dispersion with the carbon nanotube, nanowire, and/or nanorod dispersion.

The nanoclay and nanotubes, nanowires or nanorods may be mixed at high shear for at least 30 minutes.

The invention also provides a modified organoclay or nonadditive prepared by the methods of the invention.

The invention further provides a process for preparing a polymer nanocomposite comprising adding a modified organoclay or nonadditive of the invention to a polymer. The polymer may be selected from any one or more of thermoplastic polymers, polyolefins, fluoro-polymers, polyamides, engineering polymers such as poly ether ketones, styrenic polymers and polycarbonate, thermoset polymers, epoxy and phenolics.

The invention provides a polymer nanocomposite prepared in accordance with the invention.

In another aspect the invention provides a modified organoclay or nanoadditive having improved thermal properties.

The modified organoclay or nanoadditive may have a thermal stability increased between 20° C. to 80° C. compared to commercially available nanoclays.

The invention also provides a modified organoclay or nanoadditive having a conductivity of greater than 0.2-9.1 Sm⁻¹.

Also provided is a polymer nanocomposite having improved thermal and mechanical properties.

The invention also provides a polymer reinforced with a modified organoclay or nanoadditive prepared by the methods of the invention.

In one aspect the invention provides a nanoadditive comprising an organoclay modified with nanotubes, nanorods or nanowires, the nanoadditive having a thermal stability and/or electrical conductivity which is great than that of the unmodified organoclay.

The invention also provides a nanoadditive comprising an organoclay modified with nanotubes, nanorods or nanowires, the nanoadditive having a thermal stability as evidenced by its decomposition temperature which is at least 20° C. greater than the unmodified organoclay. The decomposition temperature may be at least 40° C., in some cases 60° C., in some cases 80° C. greater than the unmodified organoclay.

The invention also provides a nanoadditive comprising an organoclay modified with nanotubes, nanorods or nanowires, the nanoadditive having an electrical conductivity which is at least ten times greater than that of the unmodified organoclay.

In some cases the nanoadditive has an electrical conductivity which is at least one hundred times greater than that of the unmodified organoclay.

In some cases the nanoadditive has an electrical conductivity which is at least one thousand times greater than that of the unmodified organoclay.

In one aspect the nanoadditive further comprising an inherently electrically conductive polymeric material such as polyaniline.

The invention also provides a composite containing a nanoadditive of the invention. The composite may be a polymeric material.

### DEFINITIONS

The term polymer is taken to include any polymer which is capable of forming a nanocomposite with any modified organoclay of the invention. The polymer herein means a large molecule built up by repletion of small, simple chemical units. For example thermoplastic polymers, polyolefins, polyamides, fluoro-polymers, Engineering polymers like poly ether ketones, styrenic polymers and polycarbonate, thermoset polymers, epoxy and phenolics are included.

The clay used in this invention is any clay mineral both natural and synthetic capable of cation-exchange. Typical examples include smectite clay minerals like montmorillonite, saponite, bentonite, hectorite, beidellite, vermiculite and mica.

Organically modified clays, also called organoclays are usually produced by making water dispersion phyllosilicate clay, usually a smectite clay, and adding to it a quaternary ammonium salt of long chain fatty acidor quaternary ammonium compounds to produce an organically modified clay by cation exchange reaction and adsorption. The alkyl cation exchanged onto the clay platelets renders the hydrophilic clay organophilic and transformation makes the clay more easily dispersible into the polymer composite. In particular, the term organoclay includes the ion-exchanged reaction product of a smectite clay.

The term inherently conductive polymer (ICP) refers to organic polymers which have poly congugated π-electron system (e.g double bonds, aromatic or hetroaromatic rings or triple bonds). Examples of such polymers include polyaniline, polythiophene, polypyrrole and polyacetylene. A more comprehensive list is given in Handbook of conducting polymers, A. G. McDiarmuid and R. B. Kane, Marcel Dekker, New York, Vol 1. Polyaniline is an example of such an inherently conductive polymer.

### BRIEF DESCRIPTION OF THE DRAWINGS

The invention will be more clearly understood from the following description of two embodiments thereof, given by way of example only with reference to the accompanying drawings in which:—

FIGS. 1(a) and 1(b) show TGAs of carbon nanotube-modified Nanoclays prepared as described in Example 1, and TGA's of commercially available organoclays;

FIGS. 2(a) and 2(b) show TGAs of carbon nanotube-modified organoclays prepared as described in Example 2 and TGA's of commercially available organoclays;

FIG. 3 shows X-ray powder diffraction patterns of carbon nanotube-modified nanoclays;

FIG. 4 are Scanning Electron Micrographs (SEM) of a) Multi wall nanotubes b) aX20K and CNT-modified Nanoclays. c) MA2HTAQMWCNT d) cX40K;

FIG. 5 shows a TGA analysis of various HDPE nanocomposites;

FIG. 6 shows a XRD analysis of a polycarbonate nanocomposite;

FIG. 7 shows a TGA analysis of polystyrene nanocomposites;

FIG. 8 shows a SEM of a polystyrene nanocomposite prepared with MA2HTMWCNT functionalised clay; and

FIG. 9 is a graph of derivative weight loss vs temperature for nanoclay modified with polyaniline and carbon nanotubes.

### DETAILED DESCRIPTION

We have found a process for preparing modified nanoclays comprising the functionalisation of nanoclays with carbon nanotubes, nanowires or nanorods and surfactants which improves the thermal properties and conductivity of the modified organoclays. The modified organoclays have significantly higher thermal stabilities than commercial nanoclays and can therefore be processed at higher temperatures than commercial clays. The modified organoclays prepared in this way are conductive in nature.

The modified organoclays are ideal for reinforcing with various types of polymers/plastics by conventional processing techniques such as injection moulding, blow moulding and extrusion. Nanocomposites prepared with the modified organoclays have enhanced thermal, mechanical, structural barrier and flame retardency properties. Composites reinforced with the modified organoclays were found to be conductive and/or antistatic in nature. The composites have application for example as automobile, aerospace, antistatic coatings, conductive interfaces, Electro static dissipation, in superconductivity, mechanical reinforcement, optoelectronic technologies, telecommunications, signal processing, packaging of electronic, semiconductor devices, medical and healthcare sectors. The invention provides a polymer composite material with relatively high electrical conduction which can be blended with other plastics.

The process of the invention was also found to aid the partial opening of nanotube bundles before compounding. However during the clay modification process with carbon nanotubes the presence of solvents and surfactants was found to encourage the partial opening of nanotubes bundles. This makes it easier for the dispersion of the nanotubes in polymers which are difficult under existing processing conditions for organoclays.

The modified organoclay may be employed as reinforcing filler for various polymers resulting in improved structural and conductive properties of the nanocomposites. The modified organoclays may also be used as rheological additives.

It was found that high density polyethylene (HDPE) composites containing the modified organoclay exhibited improved mechanical properties such as maximum load, tensile strength and thermal properties. HDPE composites may therefore be produced with improved thermal and mechanical properties.

Polystyrene nanocomposites which were prepared with modified organoclays of the invention showed improved thermal properties over nanocomposites prepared with commercial organoclays.

Polycarbonate nanocomposites prepared with the carbon nanotube modified organoclays of the invention were found to be conductive and the nano hardness was improved by 50-80%.

Polyethylene terephthalate nanocomposites prepared with modified clays of the invention were also found to be conductive in nature.

Epoxy composites prepared with modified clays of the invention showed improved thermal conductivity properties over nanocomposites prepared with unmodified clays.

Conventionally nanoclays are surface modified with quaternary ammonium surfactants to provide organoclays which interact with polymers of various polarities. However, some of these clays are unsuited to high temperature moulding applications because the organic modification degrades due to their low thermal stabilities, and they are therefore unsuitable for plastics such as polycarbonate, polyethylene terephthalate, etc, which are moulded at high temperatures.

In the present invention it was found that nanoclays modified with carbon nanotubes and quaternary ammonium surfactant showed significantly high thermal stabilities. The higher thermal stabilities appear to be due to the interaction between the quaternary ammonium surfactant and the nanotubes in the clay galleries. This may be a result of the nanotubes aligning along the clays.

The invention will be more clearly understood from the following examples.

Nanoclays of the invention modified with quaternary ammonium surfactant and carbon nanotubes were prepared by two different procedures.

Briefly in the first method a commercially available or in-house modified smectite type clay which has been modified with a quaternary ammonium compound is swollen using a solvent. Carbon nanotubes, nanowires or nanorods are added to the swollen clay and the solvent subsequently removed or evaporated off. The modified clay may be added to a polymer to form a nanocomposite with improved thermal properties and conductivity.

In the second method, a commercially available organoclay is dispersed in water. Carbon nanotubes, nanowires or nanowires are dispersed in a surfactant and then added to the clay suspension. A quaternary surfactant is added. The water is filtered off followed by drying resulting in a modified organoclay. The modified clay may be added to a polymer to form a nanocomposite with improved thermal properties and conductivity.

The sequence of mixing and processing has been found to have an important effect on the properties of the modified organoclay prepared.

Nanocomposites were prepared with High density Polyethylene (HDPE), Linear low density polyethylene (LLDPE), Polystyrene (PS), Nylon 11(PA11), Poly vinyleden fluoride (PVDF), Polyethylene terephthalate (PET), and Polycarbonate (PC) with a clay loading of 5-8 wt %. The samples were melt mixed in a Brabender over head mixer for 10 min at 80 rpm screw speed. The samples were hot pressed in to sheets for further analysis using Randol Hydraulic press at operating pressure of 100 KN.

### Thermo Gravimetric Analysis (TGA):

The thermal properties of modified nanoclays and composites were measured by using Perkin Elmer Pyris TGA. The measurements were carried out in air atmosphere taken from 30° C. to 900° C. at the heating rate of 10° C./min.

### Wide Angle X-Ray Diffraction:

X-ray diffraction (XRD) was performed at room temperature to measure interlayer spacing of modified nanoclays and distribution of the Nanoclays in the composites.

The x-ray beam was Cu−K_{α} (λ=0.1514 nm) radiation operated, at 40 KV and 30 mA. Data was obtained from 2-10°(2θ) at a scanning speed of 0.1 deg/min.

### Tensile Tests:

The tensile properties of the samples were measured on 100 KN tensile tester equipped with 10 kN dynamic load cell. The measurements were carried out at room temperature on the samples in the form of strips collected from the pressed composite sheets.

### Surface Resistivity Measurements:

Surface resistivity measurements were carried at room temperature using concentric ring probe according to BS EN 61340-5 standard.

### Nano Hardness:

The nano hardness of the composites was measured with Nanohardness tester (NHT, CSM instruments, Switzerland) using spherical diamond indenter with tip load of 250 mN.

### Scanning Electron Microscopy

The nanotube modified nanoclays were viewed by Scanning Electron microscopy (SEM). For SEM analysis, the samples were covered with metallic gold to obtain adequate contrast of the clay structure and nanotubes.

### Conductivity Measurements of Modified Nanoclays:

The conductivity measurements of the modified nanoclays were carried out using in-house built experimental set up. A Teflon disc which have two top and bottom electrodes to connect to multi meter or high resistance meter and a small hole with a area of 1.96×10⁻⁵ m² to hold the powder samples. The powder sample filled in a hole and the resistance of the sample was measured under various weights. The conductivity was calculated using the formula

ρ=1/R(L/A)
ρ conductivity (Sm⁻¹)
R=Resistance (Ω)
L=length of the electrode (m)
A=area of the sample hole (m²)

The full names for labels used throughout the examples are as follows:—

| Label | Name |
|---|---|
| MA | Nanoclay |
| 2HT | Surfactant |
| AQ | Surfactant |
| K F | Nanoclay [Kunipia F] |
| S—OH | Surfactant [Lakeland S—OH] |
| CH18 | Surfactant [Stearyl amine] |
| SM100 | Nanoclay [Somasif ME-100] |
| NI.30TC | Nanoclay [Nanomer I.30TC] |
| MO636 | Nano wires |
| MWCNT | Multi wall carbon nanotubes |
| SWCNT | Single wall carbon nanotubes |

### Example 1

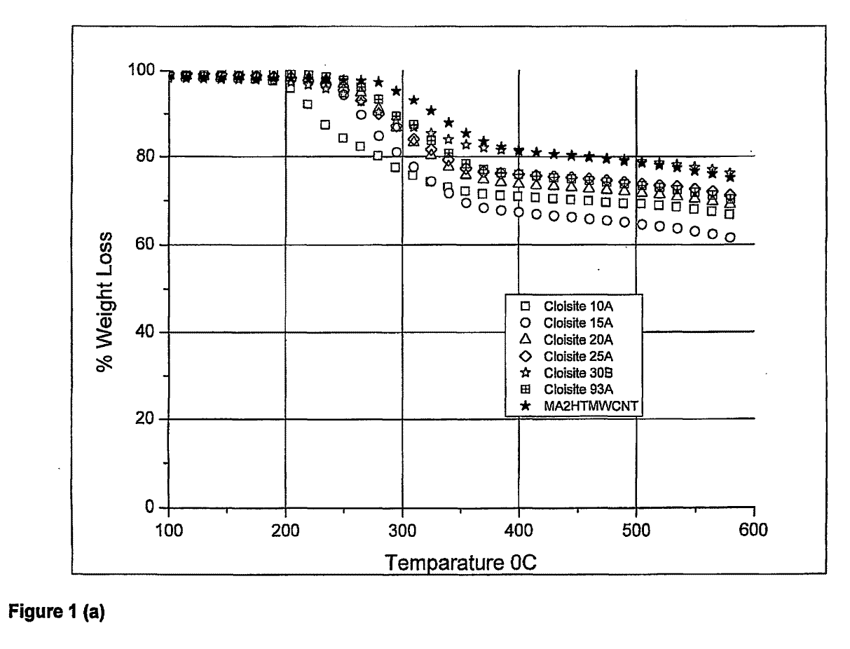

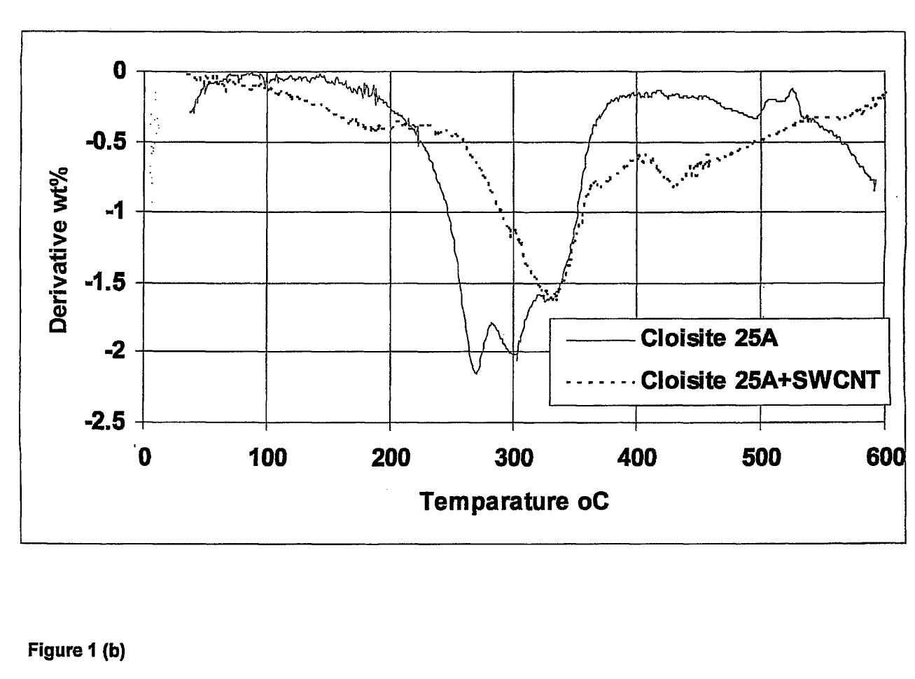

Commercially available smectite-type clay [Bentone MA, Elementis specialties, USA] was modified with dimethyl dehydrogenated tallow ammonium chloride (Arquad 2HT-75, a product of Fluka chemicals) by procedure available in the literature [Vaia, R. A.; Teukolsky, R. K.; Gainnelis, E. P. Chem. Mater, 1994, 6, 1017-1022]. The sample is an organoclay which denoted as MA 2HT. 5 g of the organoclay was swollen in 200 ml acetone at room temperature under continuous stirring. 0.5 g of thin multiwall carbon nanotubes obtained from Nanocyl, were dispersed in acetone using high power sonic tip. The resultant nanotube suspension was added to the clay suspension over 30 minutes. After 5 hours high shear mixing at room temperature the entire mixture (MA2HTMWCNT) was transferred into an open tray for the evaporation of solvent at room temperature. After complete drying the solids were milled to fine powders and sieved to uniform size. The thermal stabilities of the modified organoclay are shown in FIG. 1 compared to commercially available smectite type clays which have been modified with quaternary ammonium compounds (various grades of Cloiste organoclays). FIG. 1a shows the differential thermal analysis of commercially available Cloisite 25A clay modified with SWCNT, which clearly shows the higher thermal stability of SWCNT modified organoclay

### Example 2

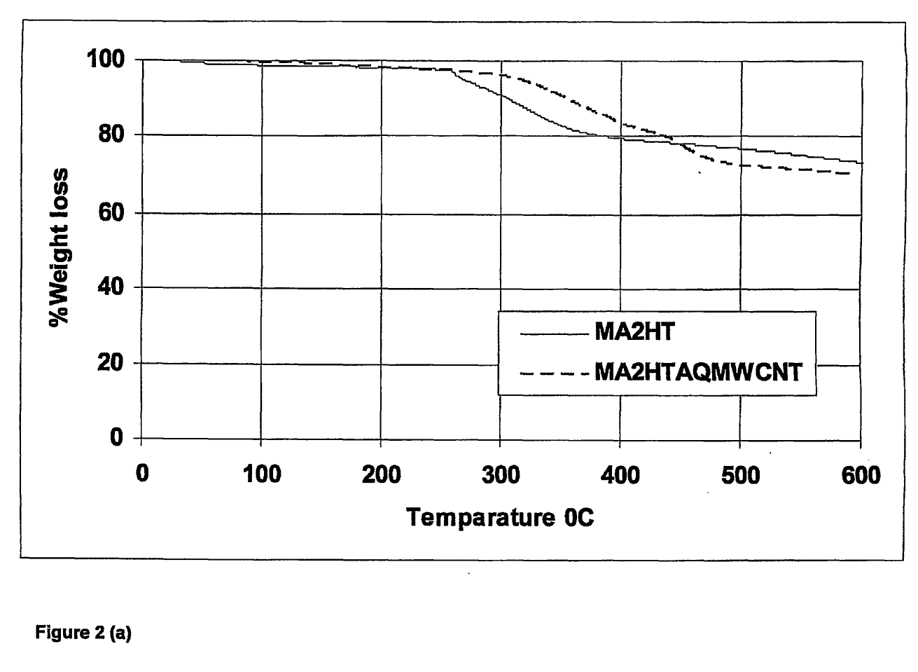

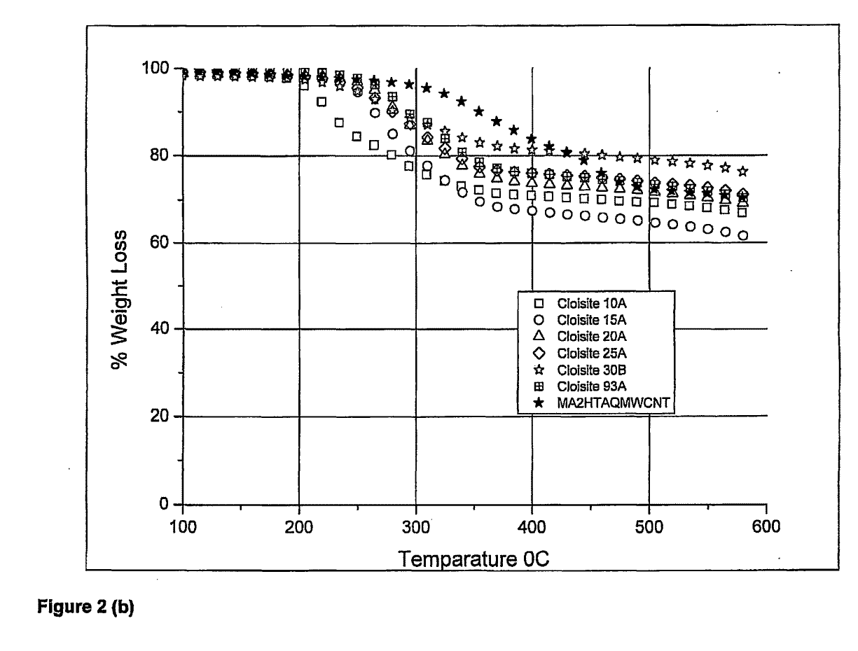

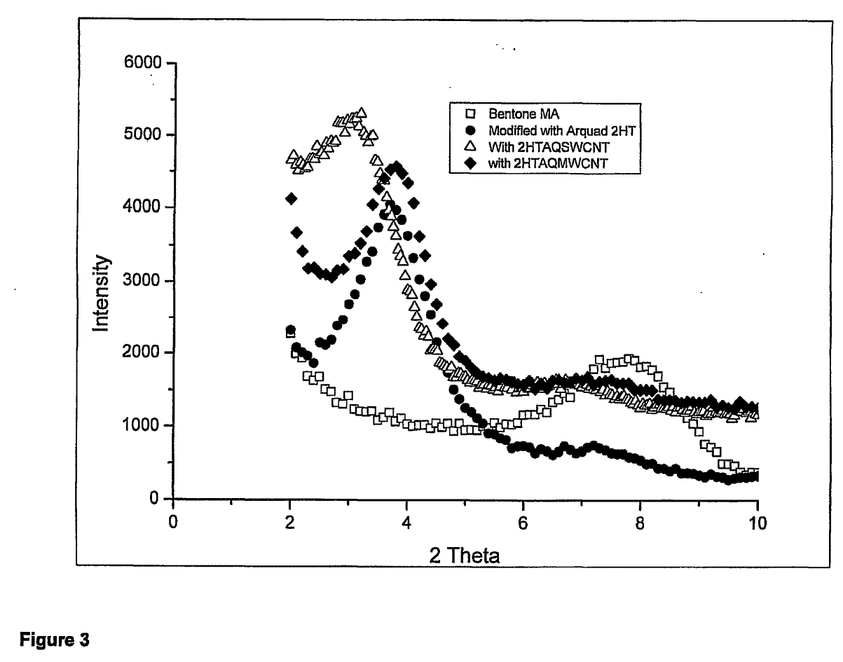

A commercially available smectite-type clay [Bentone MA, Elementis specialties, USA] was dispersed in deionised water at 60° C. at a solids concentration of 0.5-2.0 wt % by shear mixing for 30 minutes to ensure complete delamination of the clay platelets. An aqueous dispersion of multiwall carbon nanotubes [from Nanocyl] in Nanodisperse AQ non-ionic surfactant was added to the clay dispersion over 60 minutes at a nanotube:clay ratio and NanodiperseAQ to clay ratio of 10 wt %. The entire dispersion was mixed at high shear for 30 minutes. An alcoholic solution dimethyl dehydrogenated tallow ammonium chloride (Arquad 2HT-75, a product of Fluka chemicals) was prepared at a surfactant concentration of 5-5.5 wt % was prepared, then slowly added to the clay-nanotube dispersion over 30 minutes. At the end of 3 hr, the solids were decanted, filtered and washed with hot water, then dried at 60° C.). After complete drying the solids were milled to fine powders and sieved to uniform size. In another modification of the process clay [BentoneMA] was modified with single wall carbon nanotubes [from CNI] with nanotube:clay ratio of 0.5 wt % under similar conditions. FIG. 2a shows thermal analysis Bentone MA clay modified with 2HTAQMWCNT along with Bentone MA2HT. From the thermal analysis it is evident that the initial decomposition temperature of modified organo clay (MA2HTAQMWCNT) higher by 45° C. compared unmodified organoclay. FIG. 2b shows the thermal analysis of modified nanoclay compared to commercially available smectite type clays which have been modified with quaternary ammonium compounds (various grades of Cloiste organoclays). In comparison with commercial organo clays, the initial decomposition temperature of modified organo clay increased by between 20° C. to 80° C. The X-ray diffraction pattern d (001) spacing of the organoclay is shown FIG. 3. The d-spacing reflection occurs at approximately 30A° which is 6-7A° higher as compared commercial available nanoclays.

### Example 3

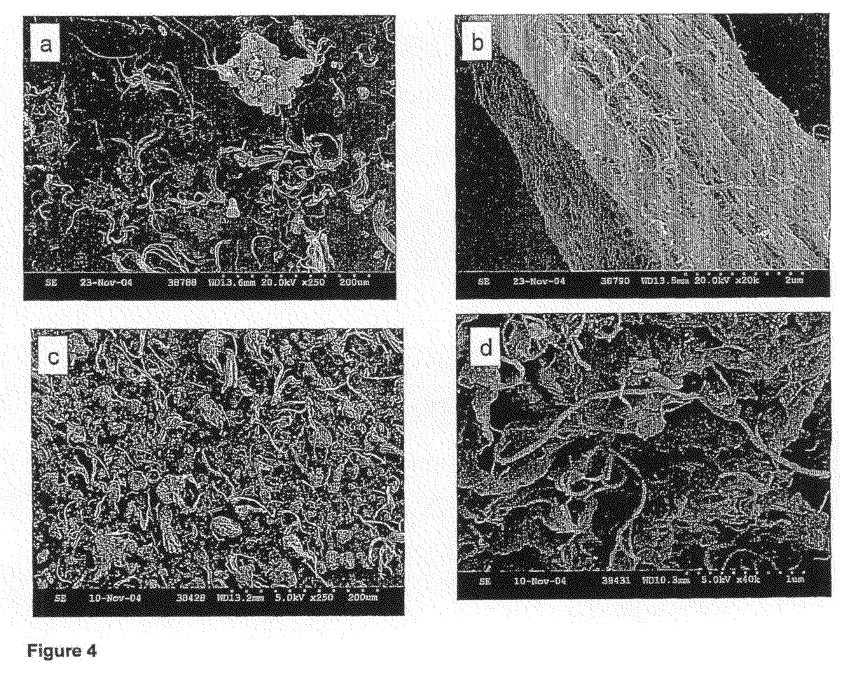

The nanotube modified nanoclays MA2HTAQMWCNT were viewed by Scanning Electron microscopy (SEM). FIG. 4 shows the SEM micrographs nanotubes modified nanoclays. The clays modified with nanotubes show clearly the distribution of the nanotubes and opened nanotube bundles throughout the clay

### Example 4

The bulk conductivity of nanotubes modified nanoclays were measured with in-house built apparatus using multi meter. Table 1 shows the conductivity of various modified clays with carbon nanotubes and nanowires. Nanoclays modified with carbon nanotubes shows conductivity in the range of 0.02-9.1 Sm⁻¹. Commercial nanoclays are non conductive in nature.

TABLE 1

| | | Bulk Conductivity | |
|---|---|---|---|
| S No | Modified Nanoclay | (Sm⁻¹) | Comment |
| 1 | Nanocyl Multi wall Carbon | 10.44 | Commercial Nanotubes |
| | nanotubes Nanocyl 3100 grade | | |
| 2 | Baytubes | 6.211 | Commercial nanotubes |
| 3 | SWCNT (CNI) | 1.232 | Commercial nanotubes |
| 4 | MO636 nano wires | 8.8 × 10⁻⁵ | Un modified nanowires |
| 5 | Arcdischarge MWCNT soot | 3.69 | Nanotubes produced in TCD |
| 8 | MA 2HT | 3.49 × 10⁻⁹ | Organo clay |
| 9 | MA2HTAQ10% MWCNT | 0.5932 | Organo clay modified with |
| | | | nanotubes |
| 10 | MACH18AQ10% MWCNT | 0.26 | Organo clay modified with |
| | | | nanotubes |
| 11 | MA2HT50% MWCNT | 8.43 | Organo clay modified with |
| | | | nanotubes |
| 12 | MA2HT50% MWCNT Arc | 0.0261 | Organo clay modified with |
| | discharge Soot | | nanotubes |
| 13 | MA2HT10% SWCNT | 0.0278 | Organo clay modified with |
| | | | nanotubes |
| 14 | MA2HTAQ50% MO636 | 5.97 × 10⁻⁰⁶ | Organo clay modified with |
| | | | nanowires |
| 15 | K FS—OH | 7.72 × 10⁻¹⁰ | Organo clay |
| 16 | K F S—OH10% MWCNT | 1.275 | Organo clay modified with |
| | | | nanotubes |
| 17 | KFS—OHAQ10% MO636 | 1.275 × 10⁻¹⁰ | Organo clay modified with |
| | | | nano wires |
| 18 | NI.30TCNanocyl7000 (1:1) | 9.137 | Organo clay modified with |
| | | | nanotubes |
| 19 | NI.30TC50% Nanocyl7000 | 4.810 | Organo clay modified with |
| | | | nanotubes |
| 20 | SM100S-OH10% MWCNT | 0.35 | Synthetic organo clay |
| | | | modified with nanotubes |

### Example 5

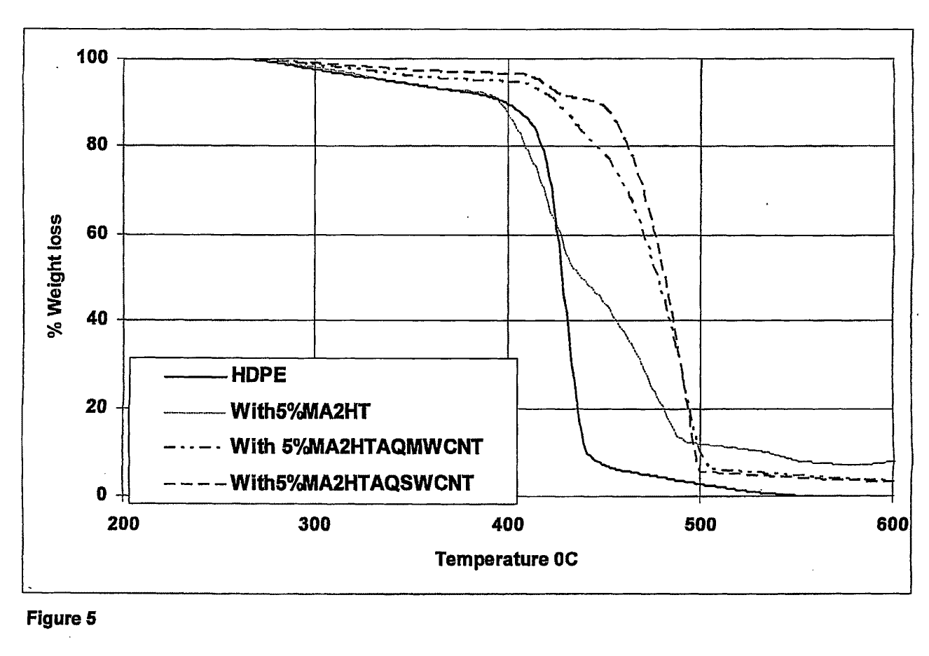

Nanocomposite containing 5 wt % of carbon nanotube modified organoclay and 95% of HDPE (Equistar Petrothene LB832001) was melt mixed in Barbender overhead mixer at a temperature of 180° C. with a screw speed of 80 rpm for 10 min. FIG. 5 shows the TGA analysis of HDPE composites prepared with nanotube modified clays. From the thermal analysis T₅₀ the temperature where 50% composite had burned off was measured shown in Table 2. The T₅₀ was increased by 50-55° C. for the composites made with nanotube modified clays. Table 3 shows the mechanical properties of HDPE nanocomposites with modified Nanoclays. HDPE composites prepared with organoclays modified with CNT shows 20-25% higher modulus and also 30-37% improvement in the maximum load over HDPE alone. HDPE composites prepared with organoclay did not show any improvement in the mechanical properties.

TABLE 2

| | | | % |
|---|---|---|---|
| Composite | T₅₀/° C. | Δ T₅₀/° C. | Increase |
| HDPE | 428 | 0 | |
| HDPE with 5% MA2HT | 437 | 9 | 2 |
| HDPE with 5% MA2HTAQSWCNT | 482 | 54 | 12 |
| HDPE with 5% MA2HTAQMWCNT | 477 | 49 | 11 |
| Polystyrene (PS) | 380 | 0 | |
| PS with 5% MA2HT | 416 | 36 | 9 |
| PS with 5% MA2HTMWCNT | 430 | 50 | 13 |
| PS with 5% MA2HTAQSWCNT | 437 | 57 | 15 |
| PS with 5% MA2HTAQMWCNT | 415 | 35 | 9 |
| LLDPE | 410 | 0 | |
| LLDPE with 5% MA2HT | NA | NA | 10 |
| LLDPE with 5% MA2HTAQSWCNT | 451 | 41 | 15 |
| LLDPE with 5% MA2HTAQMWCNT | 474 | 64 | |
| PVDF | 479 | 0 | |
| PVDF with 5% MA2HT | NA | NA | |
| PVDF with 5% MA2HTAQSWCNT | 487 | 8 | 1 |
| PVDF with 5% MA2HTAQMWCNT | 490 | 11 | 2 |
| PET | 434 | 0 | |
| PET with 5% MA2HT | 441 | 7 | 1 |
| PET with 5% MA2HTAQSWCNT | 441 | 7 | 1 |
| PET with 5% MA2HTAQMWCNT | 442 | 8 | 1 |
| Nylon 11 | 443 | 0 | |
| Nylon11 with 5% MA2HT | 453 | 10 | 2 |
| Nylon 11 with 5% MA2HTAQSWCNT | 457 | 14 | 3 |
| Nylon 11 with 5% MA2HTAQMWCNT | 454 | 11 | 2 |
| Polycarbonate (PC) | 511 | 0 | |
| PC with 5% MA2HT | NA | NA | |
| PC with 5% MA2HTMWCNT | 519 | 8 | 1.5 |
| PC with 5% MA2HTAQSWCNT | 521 | 10 | 2 |
| PC with 5% MA2HTAQMWCNT | 527 | 16 | 3 |

TABLE 3

| | Max dis- | Max. | Break | Yield |
|---|---|---|---|---|
| | placement | Load | Load | Strength |
| | (mm) | (N) | (N) | (MPa) |
| HDPE | 5.007 | 154.8 | 70.0 | 7.745 |
| With 5% MA2HT | 2.93 | 137.0 | 110.00 | 7.7054 |
| With 5% MA2HTMWCNT | 6.016 | 179.52 | 107.65 | 8.089 |
| With 5% MA2HTAQSWCNT | 6.315 | 212.4 | 129.66 | 10.06 |
| With 5% MA2HTAQMWCNT | 5.06 | 203.3 | 107.00 | 10.265 |

### Example 6

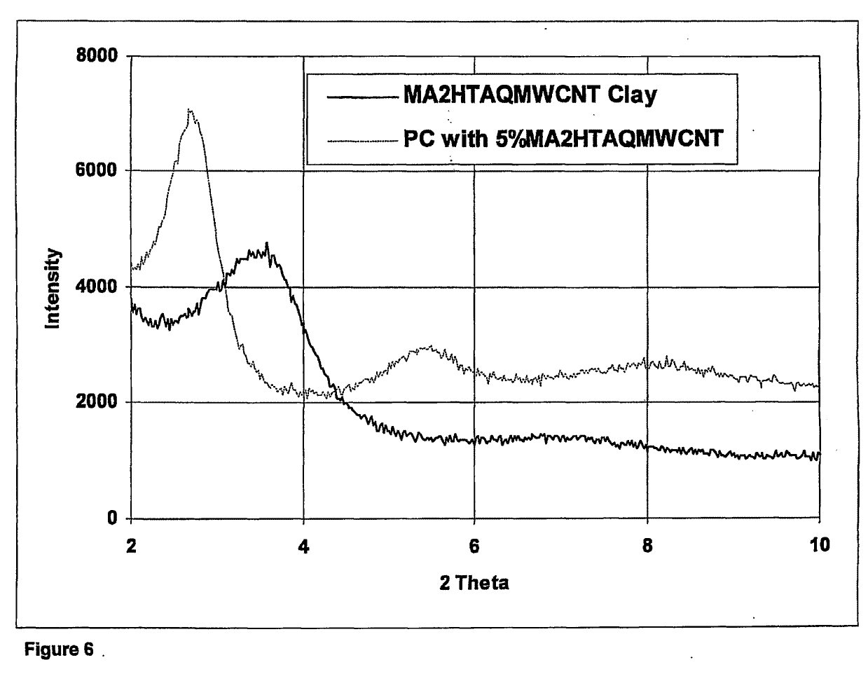

Polycarbonate (Aldrich CA No: 18, 1625) nanocomposites were prepared with various clay loading by using Brabender overhead mixer at 260° C. with 80 rpm screw speed for 10 min. From XRD analysis (FIG. 6) it is evident that polycarbonate nanocomposite prepared with modified oragno clay shows intercalated structure. Table 2 indicates the superior thermal properties of nanocomposites compared to virgin polymer.

Table 4 shows the surface resistivity of and nano hardness of various polycarbonate nanocomposites prepared with different carbon nanotubes modified clays of the invention. It is evident that that the composites obtained with modified clays of the invention are conductive/antistatic in nature. Apart from the conductivity the nano hardness of the composites were improved by 50-80% compared to virgin polycarbonate.

TABLE 4

| | Surface | Nano |
|---|---|---|
| | Resistivity | Hardness |
| Composite | Ω/Square | (Mpa) |
| Polycarbonate | — | 103.47 |
| With 5% Kunipia F S—OH | 9.52 × 10¹⁰ | 136.66 |
| With 5% MA2HT | — | 175.99 |
| With 5% MA2HTMWCNT | 7.57 × 10⁰³ | Brittle |
| With 5% K FS—OHMWCNT | 2.32 × 10⁰⁵ | 188.07 |
| With 8% K FS—OHMWCNT | 1.62 × 10⁰³ | 155.28 |
| With 5% CNa SOHAQMWCNT | 9.43 × 10⁰⁷ | 143.44 |
| With 8% CNa S—OHAQMWCNT | 3.06 × 10⁰⁴ | 134.91 |
| With 5% KF S—OH AQMWCNT | 8.69 × 10¹⁰ | 81.86 |
| With 8% KunipiaF S—OH AQMWCNT | 8.13 × 10⁰⁷ | 87.48 |
| With 5% MA2HTAQMWCNT | 1.01 × 10¹¹ | 154.54 |
| With 8% MA2HTAQMWCNT | 3.80 × 10⁰⁹ | NA |

### Example 7

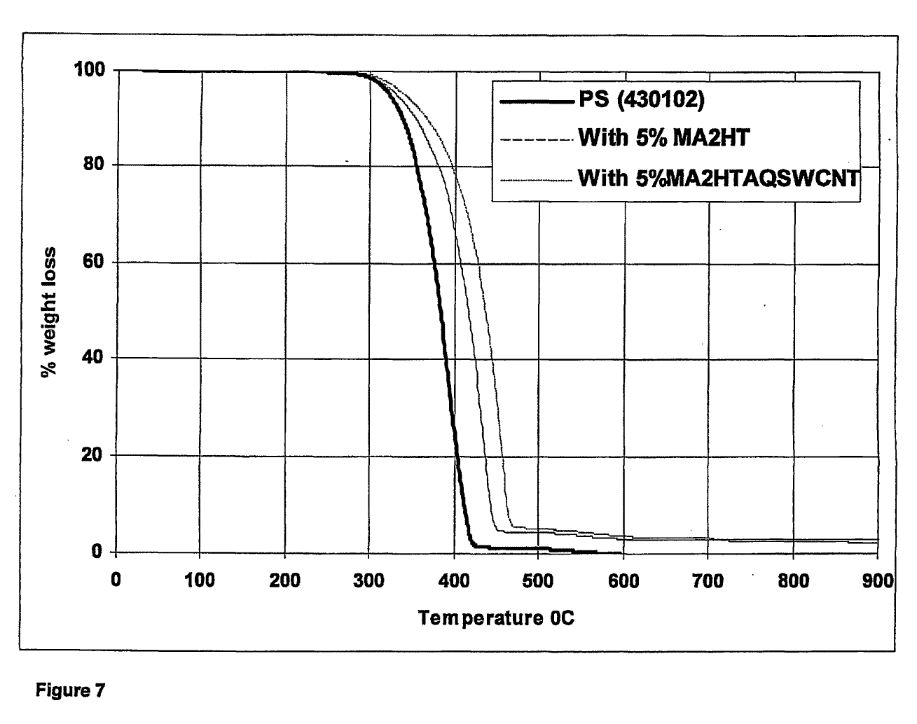

The organoclays of Example 1 and 2 are incorporated in Polystyrene (Aldrich 430102) at 5% loading by melt mixing with Brabender mixing head at 180° C. with a screw speed of 80 rpm. The resulting composites were analysed by TGA analysis and the results were shown in FIG. 7. The data clearly shows that composites obtained with organoclays of the invention have improved thermal properties.

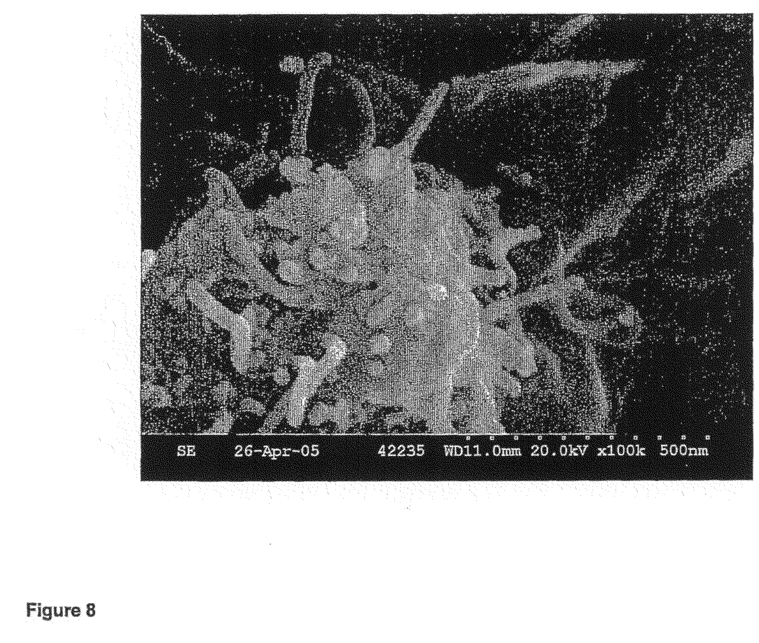

FIG. 8 shows the SEM micrograph of polystyrene nanocomposite prepared with MA2HTMWCNT functionalised clay. It is evident that the CNT's are being opened and pulled out from the fracture surface where the individual CNT aligned with the loading direction, implying that these CNTs were exerting a reinforcing effect for the polystyrene matrix material.

### Example 8

Modified clays of Example 1 and 2 were incorporated in Polyethylene terephthalate PET (PermaClear) by melt mixing the polymer using Brabender mixing head at 260° C. Table 5 shows the surface Resistivity of the PET composites. It is clear that composites obtained with modified of invention are showing very low surface resistivity or rather conductive

TABLE 5

| | | Surface |
|---|---|---|
| | | Resistivity |
| S No | Composite | Ω/Square |
| 1 | PET | — |
| 2 | PET + 5% MA2HT | — |
| 3 | PET + 5% MA2HTAQSWCNT | — |
| 4 | PET + 5% MA2HTAQMWCNT | 9.04 × 10⁵ |
| 5 | PET + 5% MA2HTMWCNT | 2.84 × 10⁴ |

### Example 9

Epoxy composites were prepared by solution blending process. 2 wt % of modified nanoclays was mixed with Bisphenol A propoxylate (IPO/phenol) diglycidyl ether [epoxy resin] at 60° C. for 30 min to obtain a homogeneous dispersion. The mixture was allowed to cool down to room temperature and 10 wt % of hardner was added. The mixture was heated to 60° C. and stirred for 10 min until the hardnes well mixed with nanoclay/epoxy dispersion. The polymerisation mixture poured into a Teflon mould with the dimensions of 5 cm×10 cm×0.1 cm. The samples were cured in an oven at 100° C. for 12 hours

Table 2 shows the thermal properties of epoxy composites prepared with various modified clays. The T₅₀ was increased by 25° C. for the composites made with nanotube modified clays.

Thermal conductivity measurements were carried using composites prepared with different modified nanoclays. Table 6 shows the thermal conductivity of the various epoxy nanocomposites. The thermal conductivity measurements showed that 11% increase in the thermal conductivity of the composite prepared with nanotubes modified nanoclays

TABLE 6

| | Thermal conductivity |
|---|---|
| Composite | (W/mK) |
| Pure epoxy | 0.254 |
| With 2% MA2HT | 0.256 |
| With 2% MA2HTAQSWCNT | 0.242 |
| With 2% MA2HTAQMWCNT | 0.284 |

The following section gives examples of the introduction of additional elements to nanoclay modified using nanotubes, nanowires or nanorods. Such additional elements may comprise elements that contribute to enhanced conductivity and/or are less expensive than nanotubes, but still miscible into a nanoadditive system. By way of example, nanoadditive systems were prepared using inherently conductive polymers (ICP) such as polyaniline. In this case both the nanotube and polyaniline components are electronically conductive and can contribute to the overall nanoadditive conductivity. Processing of such composite nanoadditives involves nanoclay+nanotube+ICP+surfactant with chemical processing. One advantage of utilising ICP's is that lower concentrations of nanotubes are required to achieve desired properties. In all cases the produced nanoadditives can be mixed, for example by thermal blending or solution mixing, with specific polymers to produce nanocomposites with enhanced thermal stability and/or electrical conductivity. Examples of such polymers include polyaniline, polypyrrole, polyacetylene, polydiacetylene, polythiophene, polyphenylene, poly 3,4-ethylenedioxy thiophene, polytoluidine

Modification of Nanoclay with Polyaniline and SWCNT:

### Example 9

A commercially available organically modified montmorillonite clay (Cloisite 25A, from Southern Clay Products, USA) was modified with polyaniline and SWCNT. Cloisite 25A was modified with polyaniline using a slightly modified procedure reported in the literature (J. D. Sudha and T. Sasikala, Polymer 48 (2007)338-347). Cloisite 25A was dispersed in 80:20 water:iso propanol mixture at 60° C. at solid concentration of 1.0 wt % by shear mixing for 12 hr. 4.3 g of distilled aniline (0.05 moles) and 16.32 g (0.05 moles) of dodecyl benzene sulphonic acid dispersed in 400 ml distilled water at 80° C. The emulsion was then added drop wise to the clay dispersion. The mixture was cooled down to 0° C. by keeping in an ice bath and pH was adjusted to 2-2.5 with 1M HCl. The oxidant initiator (NH4)₂S₂O₈ 0.06 moles dissolved in 100 ml of distilled water was then added dropwise to initiate the polymerisation. At the end of 6 hr reaction time the dark green precipitate was isolated by adding methanol, filtered, washed with deionised water and dried at 60° C. in vacuum oven and the sample denoted as Cloisite25ADPA

1 g of Cloisite25ADPA was dispersed in 80 ml of N-methylpyrrolidone (NMP) at room temperature in a sonic bath. 2 mg (0.2%) of purified SWCNT (from Nanocyl) dispersed in 20 ml of NMP using sonic tip was added to the clay suspension describe above in NMP. The entire mixture was sonicated in a sonic bath for 2 hr. The final modified clay was recovered by precipitating the suspension in 1 lit of water. The precipitate was filtered and washed with excess water and dried in an oven at 60° C.

The bulk conductivity of Polyaniline and SWCNT modified nanoclays were measured with in-house built apparatus using multi meter. Table 7 below shows the conductivity of modified clay with polyaniline and SWCNT. Nanoclays modified with polyaniline and SWCNT shows double the conductivity of nanoclays modified with polyaniline alone. Commercial nanoclays are non conductive in nature.

TABLE 7

| S | | |
|---|---|---|
| No | Modified Nanoclay | Bulk Conductivity (Sm⁻¹) |
| 1 | Cloisite 25A | Not measurable |
| 2 | Cloisite25A + SWCNT | Not measurable |
| 3 | Closite 25A modified with polyaniline | 2.0 × 10⁻² |
| | DBSA doped | |
| 4 | Closite 25A modified with polyaniline | 4.7 × 10⁻² |
| | DBSA doped and SWCNT | |

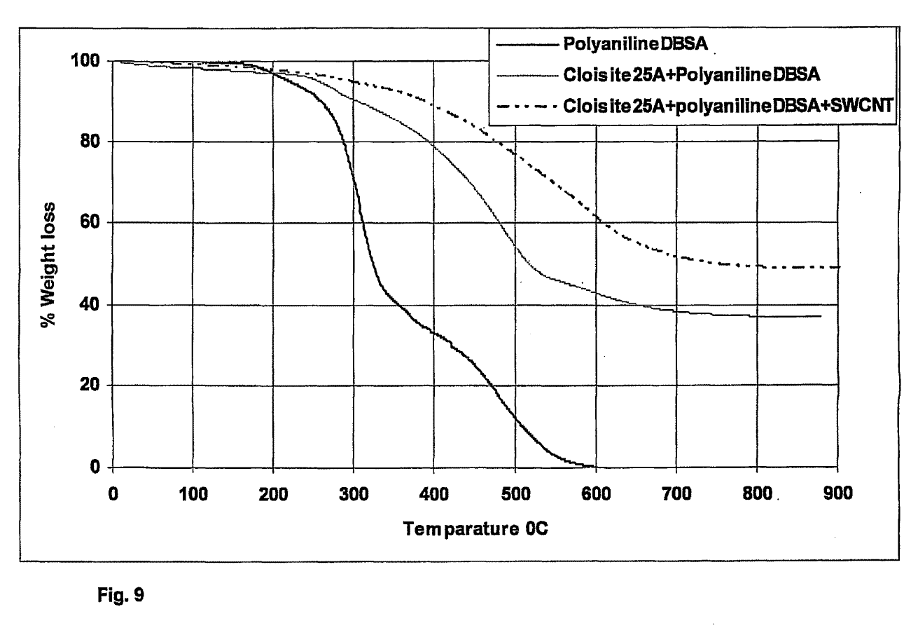

From the TGA analysis of modified nanoclays it is clearly evident that nanoclays modified with polyaniline and SWCNT showed improved decomposition temperature by 40° C. when compared clay modified polyaniline as represented in FIG. 9

The invention is not limited to the embodiments hereinbefore described which may be varied in detail.

1-33. (canceled)

34. A process for the preparation of modified nanoclay comprising the steps of
providing an organoclay;
dispersing the organoclay in a solvent or mixture of solvents and/or surfactant;
providing nanotubes or nanowires;
dispersing the nanotubes or nanowires in a solvent or mixture of solvents and/or surfactant; and
mixing the organoclay suspension with the nanotube and/or nanowire suspension.

35. The process as claimed in claim 34 wherein the organoclay is dispersed in a surfactant and suspended in a solvent prior to mixing with the nanotubes or, nanowires.

36. The process as claimed in claim 35 wherein the nanotubes or nanowires are dispersed in a solvent.

37. The process as claimed in claim 34 wherein the organoclay is suspended in a solvent and the nanotubes, nanowires or nanorods are dispersed in a surfactant prior to mixing.

38. The process as claimed in claim 37 wherein after the mixing of the organoclay suspension with the nanotube, nanowire or nanorod dispersion a surfactant is added.

39. The process as claimed in claim 34 wherein the solvent is selected from any one or more of water, acetone, ethanol, methanol, butanol, choloform, demethyl formamide, tetrahydrofuran, dimethylacetamide, N-methylformamide, xylene, toluene, dimethyl sulfoxide, propylene and carbonate.

40. The process as claimed in claim 34 wherein the surfactant is selected from any one or more of quaternary ammonium salts, non-ionic surfactants, and fatty acid hydroxyethyl imidazolines.

41. The process as claimed in claim 40 wherein the quaternary ammonium salts are selected from any one or more of dimethyl dehydrogenated tallow ammonium chloride, dimethyl benzyl hydrogenated tallow ammonium chloride, methyl benzyl dihydrogenated tallow ammonium chloride, and fatty acid hydroxethyl imidazolines.

42. The process as claimed in claim 34 wherein the nanotube, nanowire or nanorod is selected from any one or more of carbon nanotubes (CNT), single walled carbon nanotubes (SWCNT-CNI), MO636 nanowires, ZnO nanorods and Arc discharge multi-walled carbon nanotube (MWCNT) soot.

43. The process as claimed in claim 34 wherein the organoclay and nanotubes, nanowires or nanorods are mixed at room temperature.

44. The process as claimed in claim 34 wherein any solvent is evaporated or removed from the modified nanoclay.

45. A process for the preparation of modified nanoclays comprising the steps of
providing an organoclay;
dispersing the organoclay in a surfactant;
suspending the dispersed clay in a solvent;
providing carbon nanotubes, nanowires or nanorods;
dispersing the carbon nanotubes, nanowires and/or nanorods in a solvent; and
mixing the suspended nanoclay with the carbon nanotube, nanowire or nanorod dispersion.

46. A process for the preparation of modified nanoclays comprising the steps of
providing an organoclay;
dispersing the organoclay in a solvent;
providing carbon nanotubes, nanowires or nanorods;
dispersing the carbon nanotubes nanowires, or nanorods in a solvent; and
mixing the nanoclay dispersion with the carbon nanotube, nanowire, and/or nanorod dispersion.

47. The process as claimed in claim 45 wherein the nanoclay and nanotubes, nanowires or nanorods are mixed at high shear for at least 30 minutes.

48. The process as claimed in claim 46 wherein the nanoclay and nanotubes, nanowires or nanorods are mixed at high shear for at least 30 minutes.

49. A nanoadditive comprising an organoclay modified with nanotubes, nanorods or nanowires, the nanoadditive having a thermal stability and/or electrical conductivity which is great than that of the unmodified organoclay.

50. A nanoadditive comprising an organoclay modified with nanotubes, nanorods or nanowires, the nanoadditive having a thermal stability as evidenced by its decomposition temperature which is at least 20° C. greater that the unmodified organoclay.

51. The nanoadditive as claimed in claim 50 wherein the decomposition temperature is at least 40° C. greater than the unmodified organoclay.

52. The nanoadditive as claimed in claim 50 wherein the decomposition temperature is at least 60° C. greater than the unmodified organoclay.

53. The nanoadditive as claimed in claim 50 wherein the decomposition temperature is at least 80° C. greater than the unmodified organoclay.

54. A nanoadditive comprising an organoclay modified with nanotubes, nanorods or nanowires, the nanoadditive having an electrical conductivity which is at least ten times greater than that of the unmodified organoclay.

55. The nanoadditive as claimed in claim 54 wherein the nanoadditive has an electrical conductivity which is at least one hundred times greater than that of the unmodified organoclay.

56. The nanoadditive as claimed in claim 54 wherein the nanoadditive has an electrical conductivity which is at least one thousand times greater than that of the unmodified organoclay.

57. The nanoadditive as claimed in claim 49 further comprising an inherently electrically conductive polymeric material.

58. The nanoproduct as claimed in claim 57 wherein the conductive polymeric material comprises polyaniline.

59. The composite containing a nanoadditive as claimed in claim 49.

60. The composite as claimed in claim 59 wherein the composite is a polymeric material.
